(19) United States
(12) Patent Application Publication
(10) Pub. No.: US 2017/0374256 A1
(43) Pub. Date: Dec. 28, 2017

(54) METHOD AND APPARATUS FOR ROLLING SHUTTER COMPENSATION

(71) Applicant: QUALCOMM Incorporated, San Diego, CA (US)

(72) Inventor: Daniel Wagner, Vienna (AT)

(21) Appl. No.: 15/192,930

(22) Filed: Jun. 24, 2016

(51) Int. Cl. H04N 5/232

(52) U.S. Cl. CPC H04N 5/2329; H04N 5/23274; H04N 5/23251; G06T 2207/10028; G06T 2207/10021

(57) ABSTRACT

Disclosed are a system, apparatus, and method for rolling shutter compensation. An image having a plurality of scanlines captured at different times may be received from a rolling shutter camera where each scanline includes a plurality of 2D pixels, and where each scanline has an associated camera pose. One or more 2D pixels in a first scanline of the received image to 3D coordinates may be unprojected and the 3D coordinates may be transformed from the first scanline to a reference pose. The transformed 3D coordinates may be reprojected, and in response to the reprojecting, reference timeframe corrected 2D coordinates for the one or more 2D pixels in the first scanline may be provided.

### FIELD

The subject matter disclosed herein relates generally to image processing techniques and more specifically to processing aspects of rolling shutter image captures.

### BACKGROUND

Rolling Shutter (RS) describes an image capture method that may introduce artifacts into the resulting image. The RS artifacts typically occur as a result of the 2D sequential read-out of scanlines comprising a RS digital image capture. In contrast, RS artifacts typically do not occur with other digital image techniques (e.g., Global Shutter camera sensors) that capture an entire image all at once. RS type camera sensors typically capture scanlines in a top-to-bottom sequence independent of exposure time or frame rate. RS artifacts typically occur when the camera or object moves (e.g., changes relative position) during the read-out time of the RS camera. Read-out time is the delay or duration between reading the first (e.g., top) and the last (e.g., bottom) scanline Read-out time can be shorter or longer than exposure time or inverse frame rate. Read-out time is typically a fixed hardware property (i.e., read-out time typically does not change with frame rate). Because of the read-out time (i.e., RS delay/duration) between first and last scanlines, the first scanlines (e.g., top of the image) may depict an object or environment different (e.g., from an earlier time) than the object or environment in subsequent scanlines (e.g., scanlines captured after the first or initial scanline, such as at the bottom of the image in a top to bottom scan sequence). The difference in object or environment may lead to RS artifacts when the camera or object/environment is in motion. Some solutions to the RS problem attempt to correct RS artifacts with strictly 2D pixel analysis and manipulation. Other solutions may attempt to calculate an independent time stamp for every 2D pixel of an image captured with a RS camera. A problem with prior solutions is the relative complexity and large computational resource requirements not available for certain devices (e.g., mobile or portable devices). Therefore, new and improved techniques for processing color and depth images are desired.

### SUMMARY OF THE DESCRIPTION

Embodiments disclosed herein can correct feature point locations to a common time frame. The common time frame may be determined by selecting a scanline from other RS scanlines in an image as a reference.

Embodiments disclosed herein may relate to a method to correct rolling shutter artifacts, the method comprising: receiving, from a rolling shutter camera, an image having a plurality of scanlines captured at different times, wherein each scanline includes a plurality of 2D pixels, and wherein each scanline has an associated camera pose; unprojecting, one or more 2D pixels in a first scanline of the received image to 3D coordinates; transforming the 3D coordinates from the first scanline to a reference pose; reprojecting the transformed 3D coordinates; and providing, in response to the reprojecting, reference timeframe corrected 2D coordinates for the one or more 2D pixels in the first scanline.

Embodiments disclosed herein may also relate to a machine readable non-transitory storage medium having stored therein program instructions that are executable by a processor to: receive, from a rolling shutter camera, an image having a plurality of scanlines captured at different times, wherein each scanline includes a plurality of 2D pixels, and wherein each scanline has an associated camera pose; unproject, one or more 2D pixels in a first scanline of the received image to 3D coordinates; transform the 3D coordinates from the first scanline to a reference pose; reproject the transformed 3D coordinates; and provide, in response to the reprojecting, reference timeframe corrected 2D coordinates for the one or more 2D pixels in the first scanline.

Embodiments disclosed herein may further relate to a device to: receive, from a rolling shutter camera, an image having a plurality of scanlines captured at different times, wherein each scanline includes a plurality of 2D pixels, and wherein each scanline has an associated camera pose; unproject, one or more 2D pixels in a first scanline of the received image to 3D coordinates; transform the 3D coordinates from the first scanline to a reference pose; reproject the transformed 3D coordinates; and provide, in response to the reprojecting, reference timeframe corrected 2D coordinates for the one or more 2D pixels in the first scanline

Embodiments disclosed herein may further relate to an apparatus with means to perform depth and color camera synchronization. The apparatus may include means for receiving, from a rolling shutter camera, an image having a plurality of scanlines captured at different times, wherein each scanline includes a plurality of 2D pixels, and wherein each scanline has an associated camera pose; means for unprojecting, one or more 2D pixels in a first scanline of the received image to 3D coordinates; means for transforming the 3D coordinates from the first scanline to a reference pose; means for reprojecting the transformed 3D coordinates; and means for providing, in response to the reprojecting, reference timeframe corrected 2D coordinates for the one or more 2D pixels in the first scanline.

Other features and advantages will be apparent from the accompanying drawings and from the detailed description.

### BRIEF DESCRIPTION OF THE DRAWINGS

FIG. 1 is a block diagram of a system in which aspects of Rolling Shutter Compensation may be practiced, in one embodiment.

FIG. 2 illustrates the timing of scanline captures from a Rolling Shutter, in one embodiment.

FIG. 3 illustrates a method for implementing Rolling Shutter Compensation, in one embodiment.

### DETAILED DESCRIPTION

Aspects of the invention are disclosed in the following description and related drawings directed to specific embodiments of the invention. Alternate embodiments may be devised without departing from the scope of the invention. Additionally, well-known elements of the invention may not be described in detail or may be omitted so as not to obscure the relevant details of the invention.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage or mode of operation.

In one embodiment, a method and apparatus to perform Rolling Shutter Compensation (RSC) that aligns specific 2D feature locations to a common/reference time frame. In some embodiments, RSC enhances 6DOF pose tracking with Rolling Shutter (RS) cameras. RS artifacts may occur when a camera or objects in a scene move because of the scanline capture method implemented by RS cameras. For example, RS cameras typically capture a line of pixels at a time, which may result in a scanline (e.g., a scanline designated as a first or initial scanline) capturing a scene earlier than another scanline in an image (e.g., a scanline that is received after a previously received scanline). Determining pose from multiple scanlines captured at different times can be problematic for SfM and SLAM camera pose estimation because each scanline may have a different camera pose, and SfM and SLAM typically determines a single camera pose for each image/keyframe rather than per scanline In one embodiment, RSC receives a camera pose from SfM or SLAM assuming the whole/entire image is recorded at the same time instead of attempting multiple pose estimations for each of a plurality of scanlines Additionally, RSC does not need to determine the time stamp for each feature in an image, nor does RSC have to correct artifacts from only 2D pixel adjustments.

Some rolling shutter artifact reduction methods attempt to correct a whole image (i.e., all 2D pixels in a captured picture). However, correcting an entire image may not be possible on portable devices. Also, RS for 3D object tracking may not benefit from full image correction when the 3D object is not tracked with features of the entire image. In contrast, RSC can determine updated (i.e., corrected from RS) coordinates of specially selected pixels, and the specifically selected pixels are, in one embodiment, a subset of the entire universe of pixels comprising an image. In some embodiments, instead of correcting actual pixel locations within an image, RSC outputs corrected coordinates that may be input into a sparse SLAM (e.g., a point based SLAM system such as PTAM) or SfM system. The selection of these specially selected pixels may be determined by the particular SLAM or SfM system. For example, a SLAM system may select a subset of 2D pixels coordinates (from all available pixels in an image) at some prior point in time (e.g., using a corner detector). The SLAM selected points may be referred to as landmarks, interest points, or feature points. The SLAM system may estimate 3D coordinates of the feature points and may calculate the depth of those feature points from any viewing location and angle.

In one embodiment, RSC corrects feature point location(s) by assuming: a known read-out time, a known and assumed to be constant camera motion for a whole image frame (e.g., the same motion estimate applied across all scanlines), and a depth of each 2D point to be corrected. In other embodiments, an IMU can provide RSC with high frequency translation and rotation acceleration data. For example, if an IMU operates at 1000 Hz, and assuming an input image of 640×480 resolution, a rolling shutter delay of 33 ms (i.e., read-out time) can result in an IMU measurement every 480/(1000/33)=16 scanlines. At 1000 Hz, IMU sampling can provide motion estimation at greater rate than needed for determining motion change for each scanline, therefore RSC may assume one IMU measurement is the same for the 16 scanlines or may interpolate between a plurality of IMU measurements. As a result from processing the IMU data, RSC can determine a pose for every scanline which may or may not be different from the poses of neighboring scanlines

In one embodiment, RSC leverages a combination of the above introduced assumptions to unproject each 2D point into 3D space, transform each 2D point in 3D by the camera motion, project each 2D point in space back into a corrected 2D location, and output a RS corrected 2D location for points of interest (i.e., features).

As introduced earlier, read-out time (also referred to as RS delay or RS duration) is the delay between reading a first and a last scanline in a RS image capture. Typically read-out occurs top to bottom for an image, however other read-out sequences are also possible (e.g., bottom to top). Read-out time may be independent of exposure time of a captured image and also independent of frame rate. For example, read-out time can be shorter or longer than exposure time. Typically read-out time is a fixed hardware property and does not change with frame rate. In one embodiment, the read-out time may be determined from the image sensor manufacturer specifications, received from a configuration file, or calculated in an initial RSC setup.

In some embodiments, the read-out time (also referred to as read-out duration or read-out delay) can be determined by one or more tests for the specific device hardware. RS read-out time may be determined from hardware manufacturer specifications or measured at run-time. In some embodiments, RS read-out time may be measured offline by placing the device on an electric turntable with a camera on a rotation axis. The camera may be aimed horizontally at the environment and video recording is enabled while the turntable is activated. The time for a full rotation is measured. Video frames are received and the pixel offset between top and bottom row of a vertical structure (e.g., edge of a room) is measured. As an illustrated example, read-out time (e.g., in milliseconds or other time measurement) may be measured as the number of sheared pixels divided by the frame to frame pixel motion multiplied by 1000 (e.g., a factor of 1000 is illustrated for determining the number of milliseconds from a 1000 Hz example), and divided by the frame rate.

Assuming a time t₀ at which a first scanline is exposed and a RS read-out time D (i.e. delay), the exposure of each of the remaining N scanlines is delayed by a calculation of D divided by N (D/N). As applied to a moving RS camera, the camera pose for each scanline is slightly different because each scanline is captured at a different moment in time when the camera has a different pose. However, camera object and pose tracking systems (e.g., SLAM, SfM, etc.) typically expect each a single estimated camera pose for the entire image or keyframe. In one embodiment, the multiple (e.g., potentially different) camera poses that occur during an RS image capture is replaced with a single reference pose in order for typical tracking systems to most accurately track an object or environment. In one embodiment, RSC undoes unwanted RS effects (i.e., corrects RS artifacts affecting the feature points of an image) before SLAM or SfM reads a next or subsequent image capture and before determining the next image capture's associated pose.

In one embodiment, RSC corrects specific pixel locations (features) to a common/reference time frame (e.g., middle of the image). RSC may receive a 2D pixel coordinate as input (ptPix), depth at the 2D pixel location (z), camera calibration with vertical resolution (h), current motion (M), and read-out time as a ratio of inverse frame rate (rot). In one embodiment, RSC calculates a 3D coordinate of the 2D pixel location. For example, 3D coordinate may be determined as pt=unproject(cam.pixel2ideal(ptPix))*z. Next, the RS influence may be determined from the y-coordinate of the 2D pixel location. For example, f=−rot*(ptPix.y-h/2)/h. Next, the scanline motion may be determined. For example, ptM=exp(In(M)*f). Next, a new pixel coordinate may be determined. For example, ptPixM=cam.projectToPix(ptM*pt).

In one embodiment, RSC receives a 2D pixel location as input (e.g., a 2D keypoint or feature) and knowing the 2D pixel's depth, camera intrinsics (i.e., camera calibration) and extrinsics (i.e., camera location and orientation) RSC can calculate its 3D coordinate (e.g., a 3D point in an image). The 2D pixel to 3D point process is referred to herein as the unprojection. RSC can also receive another camera location and orientation and do the inverse operation (e.g., projection as described herein) to calculate its corrected 2D pixel location (e.g., a 2D keypoint or feature in another image). In one embodiment, camera intrinsics may be constant since it is the same camera that has moved. The extrinsics of a first image is the pose of the uncorrected scanline (e.g., the pose of the camera when that scanline was captured). The extrinsics of a second image is the reference pose (e.g., the one pose to determine all pixel coordinates for).

A SLAM or SfM system may convert pixels to ideal and radial undistortion. For example, a SLAM or SfM pipeline may include pixel coordinate to ideal conversion, then perform undistort, and lastly convert to camera coordinates. In one embodiment, RSC occurs between the undistort and camera coordinate conversion. Because pixel and ideal coordinates may already be stored for each observation no changes are necessary to the aforementioned SLAM or SfM pipeline in order to incorporate RSC. For example, ideal coordinates (i.e., camera coordinates) are coordinates free of lens distortion and camera intrinsics. Camera lenses typically introduce some form of lens distortion that may be measured and adjusted (e.g., fixed or improved). Distortion adjustment/compensation may move features to different coordinates. After correcting for lens distortion, other effects (e.g., intrinsics such as focal length, non-square pixels, and the projection center) may also be adjusted or corrected to convert from pixels (e.g., device specific coordinates) to rays (e.g., device unrelated geometry). 2D coordinates with a geometric meaning may be referred to as ideal coordinates. For example, an ideal coordinate of <x,y> can be treated as the 3D ray <x,y,1> with one end at camera center and extending to the location on an object that resulted in the pixel.

In some embodiments, RS estimation may be performed as part of pose estimation and/or in bundle adjustment. For example, as part of methods to calculate the rolling shutter effect by relating the assumed image position of features with the measured image position of features.

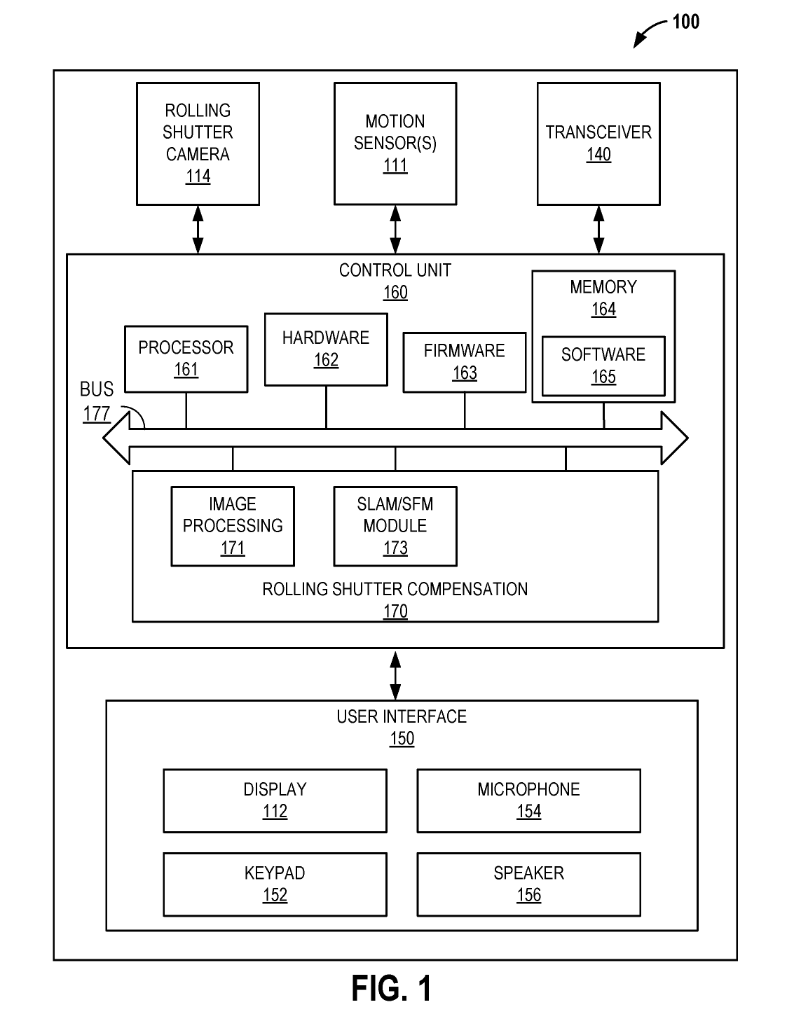

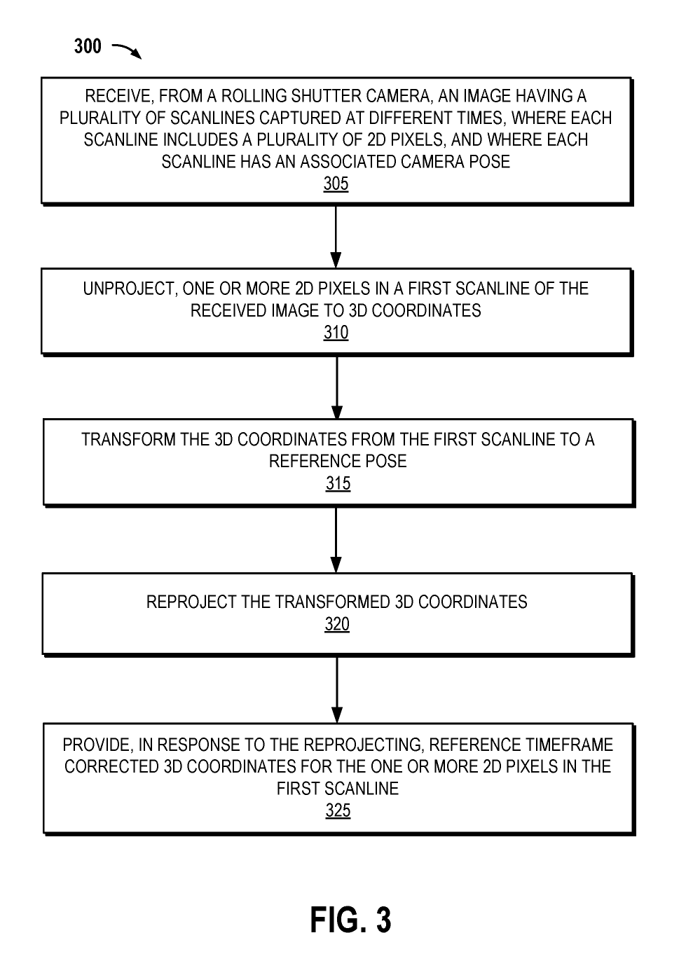

FIG. 1 is a block diagram illustrating an exemplary system in which embodiments of the RSC system may be practiced. The system may be a device 100, which may include a general purpose processor 161, Image Processing module 171, SLAM/SfM module 173, and a memory 164. The device 100 may also include a number of device sensors coupled to one or more buses 177 or signal lines further coupled to at least the Image Processing 171, and SLAM/SfM 173 modules. Modules 170, 171, and 173 are illustrated separately from processor 161 and/or hardware 162 for clarity, but may be combined and/or implemented in the processor 161 and/or hardware 162 based on instructions in the software 165 and the firmware 163. Control unit 160 can be configured to implement methods of performing RSC (e.g., RSC module 170) as described herein. For example, the control unit 160 can be configured to implement functions of device 100 (e.g., at least the method illustrated in FIG. 3 below).

Device 100 may be a: server, mobile device, wireless device, cell phone, augmented reality device (AR), personal digital assistant, wearable device (e.g., eyeglasses, watch, head wear, or similar bodily attached device), mobile computer, tablet, personal computer, laptop computer, data processing device/system, or any type of device that has processing capabilities.

In one embodiment, device 100 is a mobile/portable platform (e.g., client). Device 100 can include a means for capturing an image, such as RS camera 114 and may optionally include motion sensors 111, such as accelerometers, gyroscopes, electronic compass, or other similar motion sensing elements. Device 100 may also capture images on a front or rear-facing camera (e.g., RS camera 114). The device 100 may further include a user interface 150 that includes a means for displaying an augmented reality image, such as the display 112. The user interface 150 may also include a keyboard, keypad 152, or other input device through which the user can input information into the device 100. If desired, integrating a virtual keypad into the display 112 with a touch screen/sensor may obviate the keyboard or keypad 152. The user interface 150 may also include a microphone 154 and speaker 156, e.g., if the device 100 is a mobile platform such as a cellular telephone. Device 100 may include other elements unrelated to the present disclosure, such as a satellite position system receiver, power device (e.g., a battery), as well as other components typically associated with portable and non-portable electronic devices.

Device 100 may communicate via one or more wireless communication links through a wireless network that are based on or otherwise support any suitable wireless communication technology. For example, in some aspects, device 100 may be a client or server, and may associate with a wireless network. In some aspects the network may comprise a personal area network (e.g., an ultra-wideband network, a local area network, or a wide area network. A wireless device may support or otherwise use one or more of a variety of wireless communication technologies, protocols, or standards such as, for example, 3G, LTE, Advanced LTE, 4G, CDMA, TDMA, OFDM, OFDMA, WiMAX, and Wi-Fi. Similarly, a wireless device may support or otherwise use one or more of a variety of corresponding modulation or multiplexing schemes. A mobile wireless device may wirelessly communicate with other mobile devices, cell phones, other wired and wireless computers, Internet web sites, etc.

In one embodiment, a RSC capable device (e.g., device 100) can also perform 6DOF SLAM (e.g., SLAM/SfM module 173) or structure from motion (SfM) tracking of an object or environment. 6DOF SLAM or SfM tracking can associate features observed from input images from RS camera 114 to a 3D object or environment map. In one embodiment, RSC determines motion of the camera at the time of a scanline capture from an inertial motion unit (IMU), or one or more motion sensors of a device. For example, a device may have an accelerometer, gyroscope, magnetometer or other sensors that may be leveraged to determine camera pose at the time of scanline capture.

Feature point associations may be used to determine the camera position and orientation (i.e., pose) related to a respective camera image. An environment map or object may include 3D feature points triangulated from two or more image frames or keyframes. For example, keyframes may be selected from an image or video stream or feed to represent an observed scene. For every captured image, a respective 6DOF camera pose associated with the image. In some embodiments, camera pose may be determined by projecting features from the 3D map into an image or video frame and updating the camera pose from verified 2D-3D correspondences.

In one embodiment, device 100 extracts features from a captured image. A feature (e.g., feature point or interest point) as used herein is as an interesting or notable part of an image. The features extracted from the captured image may represent distinct points along three-dimensional space (e.g., coordinates on axes X, Y, and Z) and every feature point may have an associated feature location. The features in keyframes either match or fail to match (i.e., are the same or correspond to) the features of previously captured images. Feature detection may be an image processing operation to examine every pixel to determine whether a feature exists at a particular pixel. Feature detection may process an entire captured image or, alternatively certain portions or parts of the captured image.

For each captured image or video frame, once features have been detected, a local image patch around the feature can be extracted. Features may be extracted using a well-known technique, such as Scale Invariant Feature Transform (SIFT), which localizes features and generates their descriptions. If desired, other techniques, such as Speed Up Robust Features (SURF), Gradient Location-Orientation histogram (GLOH), Normalized Cross Correlation (NCC) or other comparable techniques may be used.

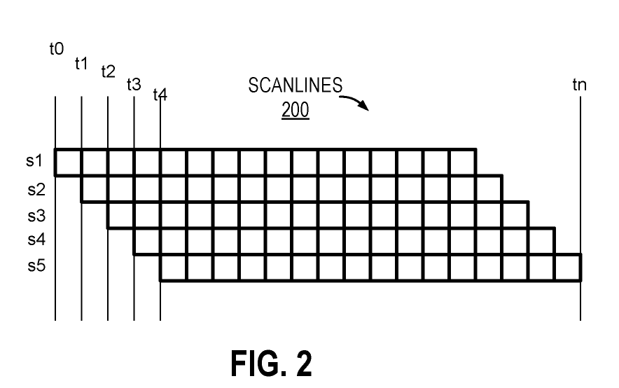

FIG. 2 illustrates the timing of scanline captures from a Rolling Shutter, in one embodiment. As introduced above, a RS camera creates an image via scanlines that occur over time. For example, as illustrated in FIG. 2, a first scanline s1 may be captured at time t0, followed by scanline s2 captured at time t1, until a final scanline for the image is captured (e.g., the last illustrated scanline starting at t4 and completed at time tn). In the illustrated example of FIG. 2, the read-out time (i.e., RS delay/duration) may be the difference between the first (i.e., s1), and the last scanline (i.e., s4) which would be calculated as t4-t0. In some embodiments, each scanline has an associated pose and a reference pose is selected to correct other scanline poses within the image. For example, in the illustrated example of FIG. 2, given five scanlines, a middle scanline (e.g., scanline s3) may be selected as the reference scanline such that scanlines s1, s2, s4, and s5 may be corrected to the reference pose provided by scanline s3. In other embodiments, other scanlines instead of a middle scanline may be selected as the reference scanline.

FIG. 3 illustrates a method for implementing Rolling Shutter Compensation, in one embodiment. At block 305, the embodiment (e.g., RSC) receives, from a rolling shutter camera, an image having a plurality of scanlines captured at different times, where each scanline includes a plurality of 2D pixels, and where each scanline has an associated camera pose. In some embodiments, each pixel in a captured image has an x-y coordinate and the y coordinate may be considered the RS scanline number. Each 2D pixel may have an associated depth value determined from a pose tracking system (e.g., SLAM, or SfM).

In one embodiment, one or more 2D pixels in the first scanline are feature points detected by an object or environment tracking system. For example, a SLAM system may determine how many feature points will be processed for the rolling shutter coordinate correction. Typically, a SLAM system has more points in its map than are projected into a current view than the SLAM system can process in real-time. There may be parts of a SLAM system that run in real-time (e.g., pose estimation for the current camera frame). Therefore, when certain parts of SLAM are running in real time, the system may select a subset of all the feature points to process according to the particular limitations of the host device (e.g., a mobile device may have limited resources for processing). The subset of feature points to process may be selected by, for example, determining a well distributed selection from a current image frame (e.g., avoiding clusters of feature points). Additionally, non-time critical aspects of SLAM, such as improving the map quality may be performed in a background thread/operation and can process all the available information, including feature points. The amount of feature points to process therefore may in some cases by dependent on a device's available computational resources.

In one embodiment, RSC assumes the camera motion during the RS image capture is known or estimated. Then we assume that know how the camera moved while the camera was exposed. E.g., from various input, such as inertial measurement sensor, or can measure the motion in the frames before and assume it is the same. One way or another can get this data (e.g., inertial is better data) In one embodiment, each scanline's associated camera pose is determined at least in part from a camera's motion. For example, an estimated camera motion during the RS image capture can provide the camera pose for each scanline. In one embodiment, the camera motion is determined by one of: extrapolating from the current image and a previous image frame, a constant read-out time (i.e., RS delay/duration) associated with the camera sensor, an inertial measurement unit, or any combination thereof.

At block 310, the embodiment unprojects, one or more 2D pixels in a first scanline of the received image to 3D coordinates. In one embodiment, unprojecting further includes referencing a known depth value for the one or more 2D pixels.

Unprojection, as used herein, is a term coming from the usage of homogenous coordinates. Projection, as described herein, is the process of reducing the number of dimensions (e.g., going from 3D to 2D). This naturally may involve the loss of information. In the case of 3D to 2D, depth information may be lost in the projection. Unprojection undoes the projection. Because depth may be lost as part of projection RSC may reference additional information to transform a 2D coordinate into a 3D coordinate.

At block 315, the embodiment transforms the 3D coordinates from the first scanline to a reference pose. In one embodiment a reference pose is selected from the scanlines in the captured image. The reference pose may be from a middle scanline or any other selected scanline For example, in some embodiments a reference scanline is selected from the plurality of scanlines, and the associated pose of the reference scanline determines the reference pose for transforming other scanlines (e.g., begging with a first or initially selected scanline to transform).

Transforming a 3D coordinate, as used herein, refers to calculating a new 3D coordinate from another coordinate with some form of operation. For example, moving a 3D point “x” distance to the right/left (e.g., along the X-axis) would be a transformation. Another operation may be rotating a point around some particular/chosen axis, or transforming according to a pose. To transform 3D points “rigidly” (i.e., all points transform together as if they belong to a rigid object) then we a 3×4 matrix may be used. Multiplying the point with the 3×4 matrix results in the transformed 3D point. Therefore, transformation as used herein, refers in one embodiment, to taking a 3D point and calculating another 3D point. This is in comparison to projection, which is used to describe taking a 3D point and calculating a 2D point.

At block 320, the embodiment reprojects the transformed 3D coordinates. Reprojection, as used herein, refers to “projecting again,” where a projected point (a 2D point) is the source. As used herein, reprojecting infers starting with a 2D point (e.g., in some view “A”), then calculating a 3D point from the 2D point and then projecting again into a 2D point (e.g., in some view “B”).

At block 325, the embodiment provides, in response to the reprojecting, reference timeframe corrected 2D coordinates for the one or more 2D pixels in the first scanline. RS correction may be provided in response to processing the first image and before a next image is received. For example, RSC may be implemented on a per image basis, compared to other methods which may process a set of images to determine RS motion and compensate for the determined motion.

As described above, device 100 can be a portable electronic device (e.g., smart phone, dedicated augmented reality (AR) device, game device, wearable device such as eyeglasses, or other device with AR processing and display capabilities). The device implementing the AR system described herein may be used in a variety of environments, such as shopping malls, streets, rooms, or anywhere a user may take a portable device. In an AR context, a user may use device 100 to view a representation of the real world through the display of their device. A user may interact with their AR capable device by using their device's camera to receive real world images/video and superimpose or overlay additional or alternate information onto the displayed real world images/video on the device. As a user views an AR implementation on their device, real world objects or scenes may be replaced or altered in real time on the device display. Virtual objects (e.g., text, images, video) may be inserted into the representation of a scene depicted on a device display.

In one embodiment, RSC processes input from RS camera 114 to display updated real-time augmentation of a target (e.g., one or more objects or scenes). With movement of the device away from an initial reference image position, the device can capture additional images from alternate views. After extracting features and triangulating from additional keyframes, increased accuracy of the augmentation can be achieved (e.g., borders around an object may fit more precisely, the representation of the object in the scene will appear more realistic, and target placement can be more accurate relative to the camera pose).

In one embodiment, the device 100 inserts or integrates an object or graphic into a video stream or image captured by the RS camera 114 and displayed on display 112. Device 100 may optionally prompt the user for additional information to augment the target. For example, the user may be able to add user content to augment the representation of the target. User content may be an image, 3D object, video, text, or other content type that can be integrated with, or overlaid with, or replace a representation of the target.

The display may update in real-time with seamless tracking from the original scene. For example, text on a sign may be replaced with alternate text, or a 3D object may be strategically placed in the scene and displayed on device 100. When the user changes the position and orientation of the RS camera 114, the graphic or object can be adjusted or augmented to match the relative movement of the RS camera 114. For example, if a virtual object is inserted into an augmented reality display, camera movement away from the virtual object can reduce the size of the virtual object relative to the distance traveled by the RS camera 114. For example, taking four steps back from a virtual object should cause a greater reduction in size of the virtual object compared to taking a half step back from the virtual object, all other variables being equal. Motion graphics or animation can be animated within the scene represented by the device. For example, an animated object can “move” within a scene depicted in the AR display. Embodiments described herein can also be implemented in ways other than AR (e.g., robot positioning and navigation).

RSC may be implemented as software, firmware, hardware, module(s) or engine(s). In one embodiment, the previous RSC description is implemented by the general purpose processor 161 in device 100 to achieve the previously desired functions (e.g., at least the method illustrated in FIG. 3). In one embodiment, RSC may be implemented as an engine or module which may include additional subcomponents. In other embodiments, features of one or more of the described subcomponents may be combined or partitioned into different individual components, modules or engines.

The teachings herein may be incorporated into (e.g., implemented within or performed by) a variety of apparatuses (e.g., devices). In one embodiment, RSC is an engine or module executed by a processor to receive images or video as input. One or more aspects taught herein may be incorporated into a phone (e.g., a cellular phone), a personal data assistant (“PDA”), a tablet, a mobile computer, a laptop computer, a tablet, an entertainment device (e.g., a music or video device), a headset (e.g., headphones, an earpiece, etc.), a user I/O device, a computer, a server, a point-of-sale device, an entertainment device, a set-top box, or any other suitable device. These devices may have different power and data requirements and may result in different power profiles generated for each feature or set of features.

In some aspects a wireless device may comprise an access device (e.g., a Wi-Fi access point) for a communication system. Such an access device may provide, for example, connectivity to another network through transceiver 140 (e.g., a wide area network such as the Internet or a cellular network) via a wired or wireless communication link. Accordingly, the access device may enable another device (e.g., a Wi-Fi station) to access the other network or some other functionality. In addition, it should be appreciated that one or both of the devices may be portable or, in some cases, relatively non-portable.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, engines, circuits, and algorithm steps described in connection with the embodiments disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

In one or more exemplary embodiments, the functions or modules described may be implemented in hardware (e.g., hardware 162), software (e.g., software 165), firmware (e.g., firmware 163), or any combination thereof. If implemented in software as a computer program product, the functions or modules may be stored on or transmitted over as one or more instructions (e.g., program instructions or code) on a non-transitory computer-readable medium. Computer-readable executable media can include both computer storage media and communication media including any medium that facilitates transfer of a computer program from one place to another. A storage media may be any available media that can be accessed or executed by a computer, or data processing device/system. By way of example, and not limitation, such non-transitory computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a web site, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of non-transitory computer-readable media.

The previous description of the disclosed embodiments is provided to enable any person skilled in the art to make or use the embodiments herein. Various modifications to these embodiments will be readily apparent to those skilled in the art, and the generic principles defined herein may be applied to other embodiments without departing from the spirit or scope of the embodiments described herein. Thus, the description is not intended to be limited to the embodiments shown herein but is to be accorded the widest scope consistent with the principles and novel features disclosed herein.

What is claimed is:

1. A method to correct rolling shutter artifacts, the method comprising:
receiving, from a rolling shutter camera, an image having a plurality of scanlines captured at different times, wherein each scanline includes a plurality of 2D pixels, and wherein each scanline has an associated camera pose;
unprojecting, one or more 2D pixels in a first scanline of the received image to 3D coordinates;
transforming the 3D coordinates from the first scanline to a reference pose;
reprojecting the transformed 3D coordinates; and
providing, in response to the reprojecting, reference timeframe corrected 2D coordinates for the one or more 2D pixels in the first scanline.

2. The method of claim 1, further comprising:
selecting a reference scanline from the plurality of scanlines, wherein the associated pose of the reference scanline determines the reference pose for transforming the first scanline

3. The method of claim 1, wherein the one or more 2D pixels in the first scanline are feature points determined from an object or environment tracking system.

4. The method of claim 1, wherein the unprojecting further includes referencing a known depth value for the one or more 2D pixels.

5. The method of claim 1, wherein RS correction is provided in response to processing the first image and before a next image is received.

6. The method of claim 1, wherein each scanline's associated camera pose is determined at least in part from a camera's motion, wherein the camera motion is determined by one of:
extrapolating from a previous two or more image frames,
a constant read-out time associated with the camera sensor,
an inertial measurement unit, or
any combination thereof.

7. A device to perform rolling shutter compensation comprising:
memory; and
a processor coupled to the memory and configured to:
receive, from a rolling shutter camera, an image having a plurality of scanlines captured at different times, wherein each scanline includes a plurality of 2D pixels, and wherein each scanline has an associated camera pose;
unproject, one or more 2D pixels in a first scanline of the received image to 3D coordinates;
transform the 3D coordinates from the first scanline to a reference pose;
reproject the transformed 3D coordinates; and
provide, in response to the reprojecting, reference timeframe corrected 2D coordinates for the one or more 2D pixels in the first scanline

8. The device of claim 7, further configured to:
select a reference scanline from the plurality of scanlines, wherein the associated pose of the reference scanline determines the reference pose for transforming the first scanline.

9. The device of claim 7, wherein the one or more 2D pixels in the first scanline are feature points determined from an object or environment tracking system.

10. The device of claim 7, wherein the unprojecting further includes referencing a known depth value for the one or more 2D pixels.

11. The device of claim 7, wherein RS correction is provided in response to processing the first image and before a next image is received.

12. The device of claim 7, wherein each scanline's associated camera pose is determined at least in part from a camera's motion, wherein the camera motion is determined by one of:
extrapolating from a previous two or more image frames,
a constant read-out time associated with the camera sensor,
an inertial measurement unit, or
any combination thereof.

13. A machine readable non-transitory storage medium having stored therein program instructions that are executable by a processor to:
receive, from a rolling shutter camera, an image having a plurality of scanlines captured at different times, wherein each scanline includes a plurality of 2D pixels, and wherein each scanline has an associated camera pose;
unproject, one or more 2D pixels in a first scanline of the received image to 3D coordinates;
transform the 3D coordinates from the first scanline to a reference pose;
reproject the transformed 3D coordinates; and
provide, in response to the reprojecting, reference timeframe corrected 2D coordinates for the one or more 2D pixels in the first scanline.

14. The medium of claim 13, further comprising:
selecting a reference scanline from the plurality of scanlines, wherein the associated pose of the reference scanline determines the reference pose for transforming the first scanline.

15. The medium of claim 13, wherein the one or more 2D pixels in the first scanline are feature points determined from an object or environment tracking system.

16. The medium of claim 13, wherein the unprojecting further includes referencing a known depth value for the one or more 2D pixels.

17. The medium of claim 13, wherein RS correction is provided in response to processing the first image and before a next image is received.

18. The method of claim 1, wherein each scanline's associated camera pose is determined at least in part from a camera's motion, wherein the camera motion is determined by one of:
extrapolating from a previous two or more image frames,
a constant read-out time associated with the camera sensor,
an inertial measurement unit, or
any combination thereof.

19. An apparatus to correct rolling shutter artifacts, the apparatus comprising:
means for receiving, from a rolling shutter camera, an image having a plurality of scanlines captured at different times, wherein each scanline includes a plurality of 2D pixels, and wherein each scanline has an associated camera pose;
means for unprojecting, one or more 2D pixels in a first scanline of the received image to 3D coordinates;
means for transforming the 3D coordinates from the first scanline to a reference pose;
means for reprojecting the transformed 3D coordinates; and
means for providing, in response to the reprojecting, reference timeframe corrected 2D coordinates for the one or more 2D pixels in the first scanline.

20. The apparatus of claim 19, further comprising:
means for selecting a reference scanline from the plurality of scanlines, wherein the associated pose of the reference scanline determines the reference pose for transforming the first scanline

21. The apparatus of claim 19, wherein the one or more 2D pixels in the first scanline are feature points determined from an object or environment tracking system.

22. The apparatus of claim 19, wherein the means for unprojecting further includes means for referencing a known depth value for the one or more 2D pixels.

23. The apparatus of claim 19, wherein RS correction is provided in response to processing the first image and before a next image is received.

24. The apparatus of claim 19, wherein each scanline's associated camera pose is determined at least in part from a camera's motion, wherein the camera motion is determined by one of:
extrapolating from a previous two or more image frames,
a constant read-out time associated with the camera sensor,
an inertial measurement unit, or
any combination thereof.
